(19) United States
(12) Patent Application Publication
(10) Pub. No.: US 2024/0264819 A1
(43) Pub. Date: Aug. 8, 2024

(54) SELF-LEARNING BASED DYNAMIC STAGED DEPLOYMENT OF UPDATES

(71) Applicant: Dell Products L.P., Round Rock, TX (US)

(72) Inventors: Shailesh Jain, Bangalore (IN); Srinivasa Ragavan Rajagopalan, Bangalore (IN)

(21) Appl. No.: 18/164,710

(22) Filed: Feb. 6, 2023

(51) Int. Cl. G06F 8/65; H04L 45/00

(52) U.S. Cl. CPC G06F 8/65; H04L 45/563

(57) ABSTRACT

Self-learning based dynamic staged deployment of updates is provided. When an administrator desires to deploy an update to endpoints, the administrator can specify whether the deployment should be performed using static waves or dynamic waves. When static waves are selected, the administrator can also specify a number or percentage of the endpoints that should be part of the first wave and a multiplication factor to be used for selecting endpoints for the subsequent waves. When dynamic waves are selected, the administrator can also specify a wave attribute and a maximum first wave percentage, and such input can be used as part of various dynamic selections and calculations to deploy the update in waves.

### CROSS-REFERENCE TO RELATED APPLICATIONS

N/A

### BACKGROUND

Many enterprises, companies, or other entities use a management server to manage their endpoints. As part of this management, an administrator will typically schedule updates of the operating system, applications, drivers, profiles, etc. on each endpoint. In many cases, an entity's endpoints may have different operating systems, different sets of applications, different sets of drivers, different sets of peripherals, etc. thereby making the update process cumbersome and error prone. For example, if the same update is pushed to endpoints with different configurations, the update may likely cause at least some endpoints to malfunction. In such a case, the administrator may need to manually intervene.

To attempt to avoid problems during an update, an administrator may divide the endpoints into deployment groups where each deployment group includes endpoints having the same or similar configuration. By using deployment groups, the administrator can hopefully limit an update failure to the endpoints in a single deployment group. Yet, creating deployment groups is a manual and tedious process. In some cases, an administrator may schedule deployment groups in phases to ensure that an update is not deployed to a new deployment group until successfully deployed to a current deployment group. This again adds overhead to the update process.

An administrator may also or alternatively use a small test group of endpoints to which an update is first deployed. If the update is successfully deployed to the test group, the administrator can then proceed with the update to the remaining endpoints. Yet again, using a test group adds time to the update process and requires extra effort. In short, when an administrator needs to deploy an update to a large number of endpoints, he or she must engage in manual, tedious, and time-consuming tasks to minimize the risk of or harm from a failure in the deployment of the update.

### BRIEF SUMMARY

The present invention extends to systems, methods, and computer program products for implementing self-learning based dynamic staged deployment of updates. When an administrator desires to deploy an update to endpoints, the administrator can specify whether the deployment should be performed using static waves or dynamic waves. When static waves are selected, the administrator can also specify a number or percentage of the endpoints that should be part of the first wave and a multiplication factor to be used for selecting endpoints for the subsequent waves. When dynamic waves are selected, the administrator can also specify a wave attribute and a maximum first wave percentage, and such input can be used as part of various dynamic selections and calculations to deploy the update in waves.

In some embodiments, the present invention may be implemented by a management server as a method for implementing self-learning based dynamic staged deployment. The management server can identify a number of endpoints to be updated. The management server can create virtual groups for the endpoints to be updated. The management server can create virtual subgroups within each virtual group. The management server can then deploy an update to endpoints within each virtual subgroup in waves, where a number of endpoints that are selected for each wave is dynamically determined.

In some embodiments, the present invention may be implemented as computer storage media storing computer executable instructions which when executed implement a management server that is configured to perform a method for implementing self-learning based dynamic staged deployment. The management server can identify unique platform and operating system combinations that exist within a set of endpoints to be updated. For each unique platform and operating system combination, the management server can create a virtual group of the endpoints having the unique platform and operating system combination. The management server can also create virtual subgroups within each virtual group based on one or more wave attributes. The management server can then deploy an update to endpoints within each virtual subgroup in waves.

In some embodiments, the present invention can be implemented as a system for deploying updates that includes a management server and a plurality of endpoints. The management server can be configured to deploy an update to the plurality of endpoints using a dynamic wave approach. The management server can create virtual groups for the plurality of endpoints. The management server can create virtual subgroups within each virtual group. The management server can then deploy an update to the endpoints within each virtual subgroup in waves, where a number of endpoints that are selected for each wave is dynamically determined.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

Understanding that these drawings depict only typical embodiments of the invention and are not therefore to be considered limiting of its scope, the invention will be described and explained with additional specificity and detail through the use of the accompanying drawings in which:

FIG. 1 provides an example of a computing environment in which embodiments of the present invention may be implemented;

FIG. 2 is a flowchart of an example method for deploying updates using a static wave approach;

FIGS. 3A and 3B are a flowchart of an example method for deploying updates using a dynamic wave approach; and

FIG. 4 provides an example of how an update can be deployed using the dynamic wave approach.

### DETAILED DESCRIPTION

In this specification and the claims, an endpoint should be construed as including any end user computing device which may be managed from a management server. For example, managed devices may be desktops, laptops, thin clients, tablets, smart phones, etc. A management server may be implemented in the cloud or on-premises.

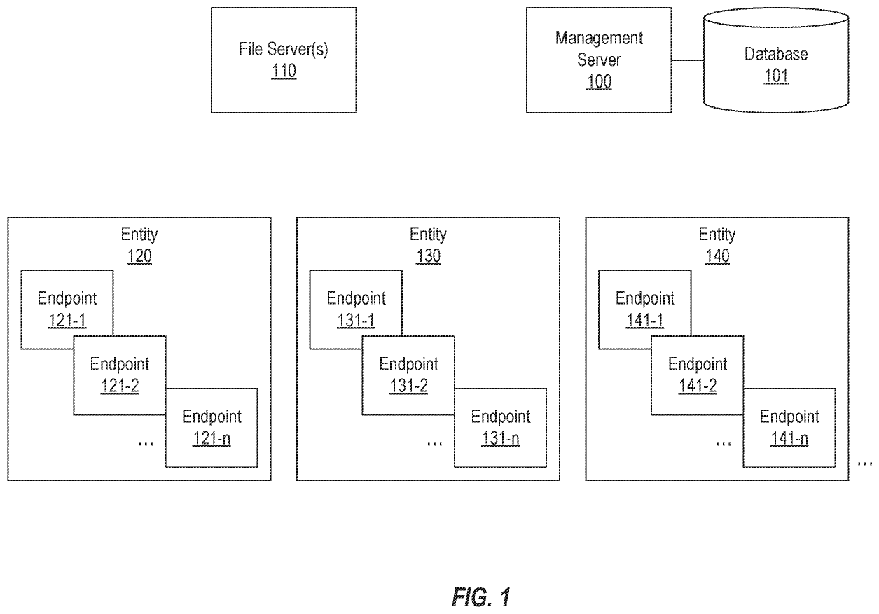

FIG. 1 provides an example of a computing environment in which embodiments of the present invention may be implemented. The computing environment includes a management server 100 which may be used by multiple entities to manage their endpoints. In the depicted example, there are three entities: entity 120 having endpoints 121-1-121-n, entity 130 having endpoints 131-1-131-n, and entity 140 having endpoints 141-1-141-n. However, there could be many more in some implementations of the present invention. In some embodiments, however, there may be a single entity that employs management server 100 to manage its endpoints. In some embodiments, the computing environment may represent a multi-tenant environment in which case entities 120, 130, and 140 can each represent a different tenant.

Management server 100 can represent any collection of network accessible components that provide the functionality described herein and may be located in the cloud or on-premises. Management server 100 may employ a database 101 to store the various types of information described herein. File server 110 can represent a repository that is accessible to the endpoints of entities 120, 130, and 140 and by which management server 100 deploys updates to these endpoints. An update could include one or more files. Each endpoint can be configured to access file server 110 (e.g., via a specified URL) to obtain each file of an update that has been scheduled for deployment to the endpoint.

As an overview, embodiments of the present invention can be employed to implement self-learning based dynamic staged deployment. When static waves are selected, an administrator can specify the number of endpoints in the first wave and a multiplication factor for determining the number of endpoints in each subsequent wave. When dynamic waves are selected, endpoints can be divided into virtual groups and virtual subgroups. A test device can be selected for each virtual subgroup and then deployment of the update can occur in waves within the virtual subgroups. The endpoints can be selected for each wave based on dynamic calculations.

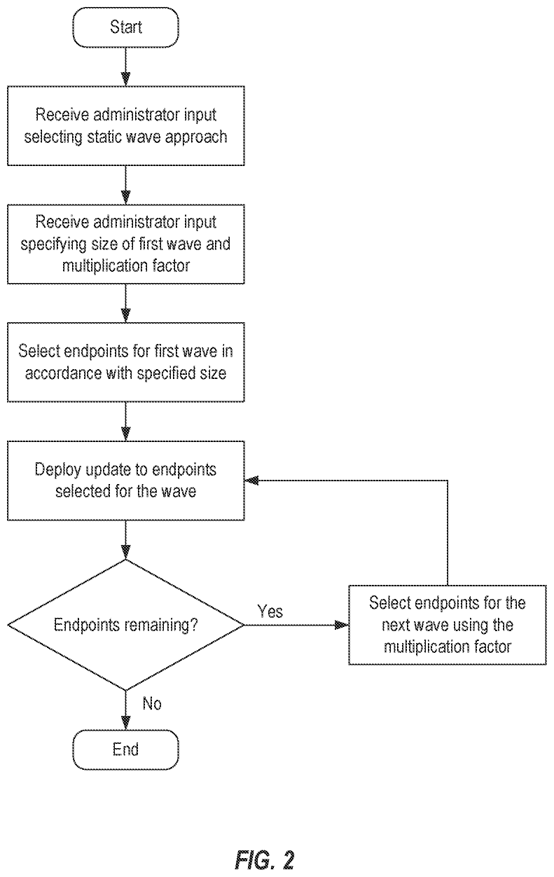

FIG. 2 is a flowchart of an example method that management server 100 can perform to deploy updates using a static wave approach. The method can start in response to an administrator selecting the static wave approach for deployment of an update to an entity's endpoints (e.g., to endpoints 120-1 through 120-n). In conjunction with the selection the static wave approach, management server 100 can receive input from the administrator that specifies a size of the first wave and a multiplication factor. For example, the administrator can specify the size of the first wave as a number of endpoints (e.g., 100) or as a percentage of all the endpoints (e.g., 1% of 10,000 total endpoints to be updated during an update window).

Next, management server 100 can select the endpoints to be included in the first wave based on the specified size of the first wave. For example, management server 100 could select 100 of endpoints 121-1 through 121-n to be included in the first wave. The update can then be deployed to the endpoints selected for the first wave. After deploying the update to the endpoints in a wave, management server 100 can determine if there are endpoints remaining. If so, management server 100 can select endpoints for the next wave using the multiplication factor. In particular, management server 100 can multiply the number of endpoints in the previous wave by the multiplication factor to yield the number of endpoints for the next wave. For example, if the first wave included 100 endpoints and the multiplication factor is 2, management server 100 could select 200 endpoints for the second wave. Management server 100 can then deploy the update to the endpoints selected for the next wave. This process can continue until no endpoints remain at which point the update process is complete.

This static wave approach provides a quick and simple way for the administrator to deploy an update in stages without requiring manual selection of deployment groups. However, the static wave approach may be limited in its effectiveness for entities having diverse endpoints. The dynamic wave approach may therefore be selected to further enhance the update process.

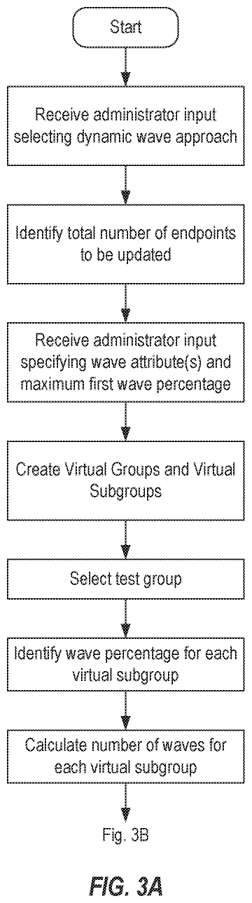

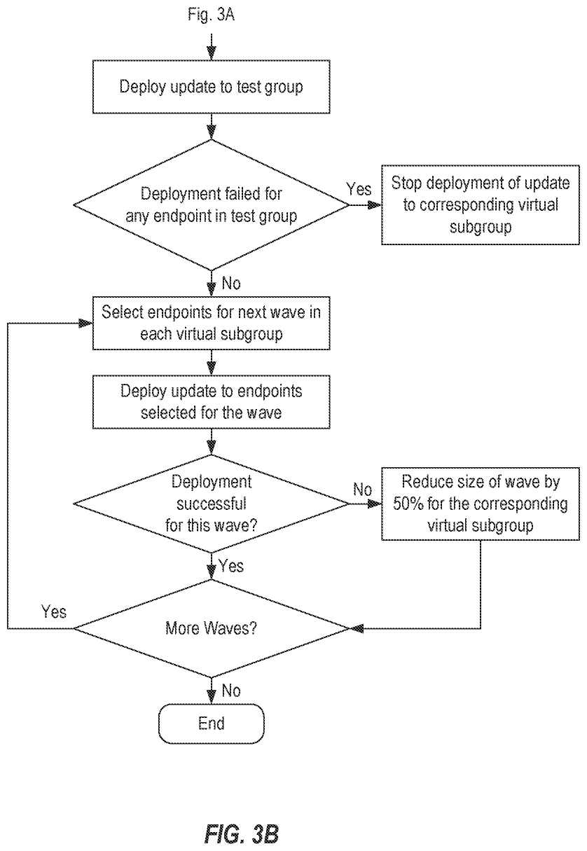

FIGS. 3A and 3B are a flowchart of an example method that management server 100 can perform to deploy updates using a dynamic wave approach. The method can start in response to an administrator selecting the dynamic wave approach for deployment of an update to an entity's endpoints (e.g., to endpoints 120-1 through 120-n). Management server 100 can initially identify the total number of endpoints to be updated. For example, endpoints 120-1 through 120-n may include 10,000 endpoints.

Management server 100 can then receive input from the administrator specifying one or more wave attributes and a maximum first wave percentage. A wave attribute can be any attribute that management server 100 may use to select virtual subgroups as further described below. The maximum first wave percentage can be used in subsequent dynamic calculations as described below.

Management server 100 may then create virtual groups and virtual subgroups. In some embodiments, management server 100 may dynamically select virtual groups by identifying each unique platform and operating system combination that is found in the endpoints to be updated. In this context, a platform can be considered the hardware of an endpoint. For example, an endpoint could be a Dell OptiPlex 3000 Micro running Windows 10 in which case management server 100 could identify OptiPlex 3000 as the platform and Windows 10 as the operating system. Management server 100 can dynamically select virtual subgroups within each virtual group using the specified wave attribute(s). For example, if the wave attribute is a location of the endpoint, each Dell OptiPlex 3000 running Windows 10 could be grouped in the same virtual group and then divided into virtual subgroups based on the location of each endpoint (e.g., one virtual subgroup for an office in Austin, Texas, one virtual subgroup for an office is San Jose, California, etc.). The number of virtual subgroups in each virtual group need not be the same (e.g., if one location only has endpoints with some of the unique platform and OS combinations).

Once management server 100 has dynamically created the virtual groups and virtual subgroups, it can create a test group by selecting one endpoint in each virtual subgroup (or some other small number of endpoints in each virtual subgroup). For example, if management server 100 created five virtual groups (e.g., due to the existence of five unique platform and OS combinations in the 10,000 endpoints to be updated) and created ten virtual subgroups for each virtual group (e.g., due to the endpoints having the five unique platform and OS combinations being distributed among ten different locations), management server 100 could select 50 endpoints to form the test group (e.g., one endpoint from each of the 50 total virtual subgroups).

Management server 100 could then identify a wave percentage to be used in dynamically calculating the number of endpoints in each virtual subgroup that will be part of a next wave as further described below. In some embodiments, management server 100 could identify the wave percentage as the number of virtual subgroups in the respective virtual group unless the number of virtual subgroups exceeds the maximum first wave percentage. For example, if the maximum first wave percentage is 20 and the number of virtual subgroups in a particular virtual group is 10, management server 100 could select 10 as the wave percentage. If, however, the number of virtual subgroups in a particular virtual group exceeds the maximum first wave percentage, management server 100 could select the maximum first wave percentage as the wave percentage for that virtual subgroup.

Management server 100 may also calculate a number of waves for each virtual subgroup. In some embodiments, management server 100 may use a recursive algorithm to dynamically calculate the number of waves that will be required to deploy the update to each endpoint in the respective virtual subgroup. For example, management server 100 could set a remaining update percentage (RUP) parameter to 100, a COUNT parameter to 1, a WAVE parameter to 0, and a wave percentage (WP) parameter to the wave percentage, and then calculate the value of the WAVE parameter as:

$$While ( RUP > 0 ) \{ RUP = RUP - ( WP * COUNT ) ; COUNT ++ , WAVE ++ \}$$

Assuming the wave percentage is 10, management server 100 could recursively calculate the value of the WAVE parameter to define the number of waves to be 4 as follows:

$$While ( 100 > 0 ) \{ RUP = 100 - ( 10 * 1 ) ; 2 , 1 \} or RUP = 90 \\ While ( 90 > 0 ) \{ RUP = 90 - ( 10 * 2 ) ; 3 , 2 \} or RUP = 70 \\ While ( 70 > 0 ) \{ RUP = 70 - ( 10 * 3 ) ; 4 , 3 \} or RUP = 40 \\ While ( 40 > 0 ) \{ RUP = 40 - ( 10 * 4 ) ; 5 , 4 \} or RUP = 0$$

Management server 100 may then commence the update process by deploying the update to the test group. For example, management server 100 could cause each endpoint in the test group to obtain the update (or their respective updates) from file server(s) 110 and install it. Management server 100 can monitor the deployment of the update to the endpoints in the test group (e.g., via an agent installed on each endpoint) to determine if the deployment failed on any of the endpoints. If the update fails on any endpoint in the test group, management server 100 can stop the deployment within the corresponding virtual subgroup. In contrast, if the update is successful on an endpoint in the test group, management server 100 can proceed with the deployment of the update to the corresponding virtual subgroup via dynamic waves. By initially deploying the update to the test group which is automatically selected based on one or more wave attributes, management server 100 can ensure that any update failure due to or associated with a wave attribute can be proactively identified and limited to a small number of the endpoints.

During the first wave, management server 100 can select a number of endpoints within each virtual subgroup equal to the wave percentage. For example, management server 100 could select 10% of the endpoints in each virtual subgroup and cause the update to be deployed to these endpoints. If the deployment of the update during the first wave is successful within a virtual subgroup, management server 100 can determine if there are additional waves and, if so, select an additional number of endpoints within the virtual subgroup for the next wave using the wave percentage. Continuing the same example as above, management server 100 could select 20% (WP*COUNT) of the total number of endpoints in the virtual subgroup to be updated as part of the second wave. If, however, the deployment during the wave is unsuccessful, management server 100 may reduce the size of the next wave by 50% (e.g., by selecting 5% (WP*½) of the endpoints in the virtual subgroup for the second wave) and adjusting the number of waves accordingly.

This process can be repeated until the calculated number of waves have been performed within each virtual subgroup. Continuing the same example, for the third wave, management server 100 could select 30% (WP*COUNT) of the endpoints in the virtual subgroup to receive the update bringing the total number of endpoints that have been updated to 60% (10% in the first wave, 20% in the second wave, and 30% in third wave). During the fourth wave, management server 100 could cause the remaining 40% (WP*COUNT) of endpoints in the virtual subgroup to be updated thereby completing the update process in the calculated number of waves (4).

This dynamic wave approach ensures that an increasing percentage of endpoints sharing one or more wave attributes are updated but only if the update is successful during a prior wave. By dynamically selecting a number of endpoints within a virtual subgroup for each wave, the update can be carried out efficiently while minimizing the impact of any failures.

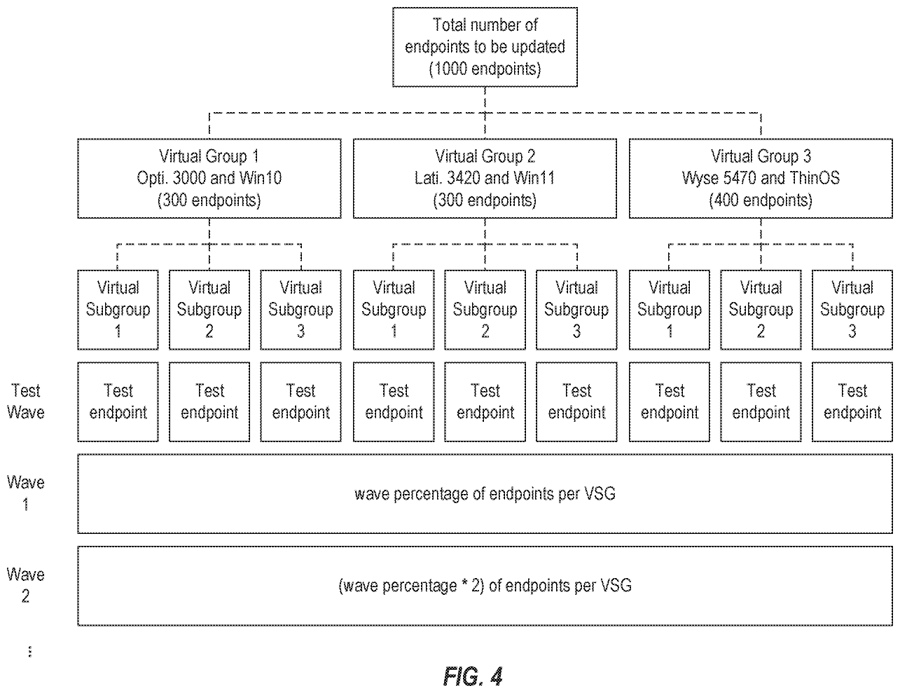

FIG. 4 provides a visual example of how the dynamic wave approach may be used to deploy an update to an entity's 1000 endpoints that are to be updated. In this example, it is assumed that there are three types of endpoints: 300 OptiPlex 3000 endpoints running Windows 10; 300 Latitude 3420 endpoints running Windows 11; and 400 Wyse 5470 endpoints running ThinOS. Accordingly, management server 100 has created three virtual groups. It is also assumed that each virtual group has been divided into three virtual subgroups such that a total of nine virtual subgroups are created. For example, if the wave attribute is location, the three virtual subgroups could be three office locations. As another example, the wave attribute could be a type of peripheral, a set of applications, a firmware version, etc.

FIG. 4 shows that a test endpoint has been selected from each virtual subgroup such that the test group includes nine endpoints each of which has a different wave attribute and/or a different platform/OS combination from the other endpoints in the test group. The update process could include an initial test wave during which the update (or respective update) is deployed to each of the test endpoints. Then, during the first wave, the update can be deployed to a percentage of endpoints within each virtual subgroup equal to the wave percentage. For each subsequent wave, the update can be deployed to a percentage of the endpoints within each virtual subgroup equal to the wave percentage multiplied by the wave count.

Embodiments of the present invention may comprise or utilize special purpose or general-purpose computers including computer hardware, such as, for example, one or more processors and system memory. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media are categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similar storage medium which can be used to store desired program code means in the form of computer-executable instructions or data structures and which can be accessed by a general purpose or special purpose computer. Transmission media include signals and carrier waves. Because computer storage media and transmission media are disjoint categories, computer storage media does not include signals or carrier waves.

Computer-executable instructions comprise, for example, instructions and data which, when executed by a processor, cause a general-purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, smart watches, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A method, implemented by a management server, for implementing self-learning based dynamic staged deployment, the method comprising:
identifying a number of endpoints to be updated;
creating virtual groups for the endpoints to be updated;
creating virtual subgroups within each virtual group; and
deploying an update to endpoints within each virtual subgroup in waves, wherein a number of endpoints that are selected for each wave is dynamically determined.

2. The method of claim 1, wherein creating virtual groups for the endpoints comprises identifying each unique platform and operating system combination that the endpoints have and creating a virtual group for each unique platform and operating system combination.

3. The method of claim 1, wherein creating virtual subgroups within each virtual group comprises creating the virtual subgroups based on one or more specified wave attributes.

4. The method of claim 1, further comprising:
selecting an endpoint from each virtual subgroup to be part of a test group; and
deploying the update to each endpoint in the test group;
wherein the update is deployed to the endpoints in a particular virtual subgroup in waves only after the update is successfully deployed to the endpoint that is in the test group and is from the particular virtual subgroup.

5. The method of claim 1, wherein the number of endpoints that are selected for each wave is dynamically determined by calculating a number of waves.

6. The method of claim 5, wherein the number of waves is calculated recursively using a wave percentage.

7. The method of claim 6, wherein the wave percentage is equal to a number of virtual subgroups in the corresponding virtual group.

8. The method of claim 6, wherein the wave percentage is a specified maximum first wave percentage.

9. The method of claim 1, wherein the number of endpoints that are selected for each wave is dynamically determined by selecting endpoints for a first wave using a wave percentage.

10. The method of claim 9, wherein the number of endpoints that are selected for each wave is dynamically determined by selecting endpoints for a subsequent wave using the wave percentage and a count of the subsequent wave.

11. The method of claim 10, wherein using the wave percentage and the count of the subsequent wave comprises multiplying the wave percentage by the count of the subsequent wave.

12. The method of claim 9, wherein the number of endpoints that are selected for each wave is dynamically determined by selecting a reduced number of endpoints for a subsequent wave when the deployment of the update in a prior wave failed.

13. The method of claim 1, further comprising:
receiving input selecting a dynamic wave approach for deploying the update.

14. The method of claim 13, further comprising:
receiving input selecting a static wave approach for deploying a second update to a number of endpoints; and
deploying the second update to the endpoints in waves, wherein a number of endpoints that are selected for each wave is selected based on a specified multiplier.

15. One or more computer storage media storing computer executable instructions which when executed implement a management server that is configured to perform a method for implementing self-learning based dynamic staged deployment, the method comprising:
identifying unique platform and operating system combinations that exist within a set of endpoints to be updated;
for each unique platform and operating system combination, creating a virtual group of the endpoints having the unique platform and operating system combination;
creating virtual subgroups within each virtual group based on one or more wave attributes; and
deploying an update to endpoints within each virtual subgroup in waves.

16. The computer storage media of claim 15, wherein the endpoints within each virtual subgroup are selected for a particular wave based on a wave percentage.

17. The computer storage media of claim 16, wherein the wave percentage is used to determine a number of waves.

18. The computer storage media of claim 15, wherein the update is deployed to endpoints within a particular virtual subgroup in waves only after the update is successfully deployed to an endpoint within the particular virtual subgroup that was selected to be part of a test group.

19. The computer storage media of claim 15, wherein a number of the endpoints within a particular virtual subgroup that are selected for a subsequent wave is reduced when the deployment of the update to endpoints within the particular virtual subgroup fails during a prior wave.

20. A system for deploying updates comprising:
a management server; and
a plurality of endpoints;
wherein the management server is configured to deploy an update to the plurality of endpoints using a dynamic wave approach by performing the following:
creating virtual groups for the plurality of endpoints;
creating virtual subgroups within each virtual group; and
deploying an update to the endpoints within each virtual subgroup in waves, wherein a number of endpoints that are selected for each wave is dynamically determined.
